(19) United States
(12) Patent Application Publication
(10) Pub. No.: US 2005/0174617 A1
(43) Pub. Date: Aug. 11, 2005

(54) Color filter configurations for linear photosensor arrays

(75) Inventors: Paul A. Hosier, Rochester, NY (US); Scott L. TeWinkle, Ontario, NY (US); Joseph P. Taillie, Pittsford, NY (US)

Correspondence Address: Patent Documentation Center;Xerox Corporation, Xerox Square 20th Floor, 100 Clinton Ave. S., Rochester, NY, 14644, US

(73) Assignee: Xerox Corporation

(21) Appl. No.: 10/773,512

(22) Filed: Feb. 6, 2004

(51) Int. Cl. H04N 1/48

(52) U.S. Cl. 358/514; 358/505

(57) ABSTRACT

An imaging apparatus, such as would be used in a digital copier, includes at least one linear array of photosensors. Along a direction of the array, the photosensors are filtered to different primary colors, such as RGB, according to a repeating pattern. The repeating pattern includes at least one substantially clear photosensor, or a photosensor sensitive to a non-primary color (K). Some possible repeating patterns thus include RGBK, RKB, BKRK, and RGBGKG.

### CROSS-REFERENCE TO RELATED APPLICATIONS

Cross-reference is made to U.S. patent application Ser. No. 09/657,342, assigned to the assignee of the present application, which has been allowed as of the filing hereof.

### TECHNICAL FIELD

The present disclosure relates to photosensor arrays in color imaging apparatus, as would be found in a hard-copy input scanner.

### BACKGROUND

Input scanners for recording images on sheets are well known in the context of digital copiers. A typical input scanner includes an image sensor array in the form of one or more chips. Image sensor arrays typically comprise a linear array of photosensors which raster scan an image bearing document and convert the reflected light from each microscopic image area viewed by each photosensor over time to image signal charges. Following an integration period, the image signals are amplified and transferred to a common output line or bus through successively actuating multiplexing transistors.

In a prior-art design of a color input scanner, there is provided a number of sets of photosensors, each set being made sensitive to one primary color. The photosensors in each array are provided with a filter thereon of one primary color. As the sensor bar including the three rows of photosensors moves along the original image, each portion of the area of the original image is exposed to each of the rows of photosensors. As each filtered row of photosensors moves past each particular area in the original image, signals according to the different primary color separations of that area are output by the particular photosensors in each row. In this way, three separate sets of signals, each relating to one primary color, will be produced by the linear arrays of photosensors.

The present disclosure is directed to filter configurations for a color input scanner, having one or more linear arrays of photosensors.

### PRIOR ART

U.S. Pat. Nos. 4,675,727 and 6,184,929 disclose filter arrangements wherein primary-colored filters are arranged in a repeating pattern along a linear array.

An arrangement of pixel-sized color filters known as “Bayer's pattern” includes, in a repeating pattern, one blue-filtered photosensor, one red-filtered photosensor, and two green-filtered photosensors, along one or two dimensions of a photosensor array.

### SUMMARY

There is provided an imaging apparatus, comprising a first linear array of photosensors arranged along an array direction. The photosensors exhibit a repeating pattern along the array direction, the repeating pattern including a first photosensor filtered to a first primary color, a second photosensor filtered to a second primary color, and a non-primary photosensor.

### BRIEF DESCRIPTION OF THE DRAWINGS

FIG. 1 shows elements of an exemplary raster input scanner.

FIGS. 2-5 are plan views of various embodiments of filter configurations for a single linear array of photosensors.

FIG. 6 is a plan view of photosensors in another embodiment, in which multiple linear arrays are incorporated in the same chip.

FIG. 7 is a plan view of an abutment area between two abutted chips.

### DETAILED DESCRIPTION

In the following description, the following naming conventions will be followed. If a photosensor is called “red-filtered,” for instance, it means that the photosensor is designed to have a peak sensitivity at a substantially red portion of the visible spectrum; the same principle holds for green, blue, or other filtering. The filtering can be enabled by placing a translucent filter over the photosensor, or providing some other physical property to the photosensor as known in the art or as will be developed in the future. A “clear” photosensor is one which is reasonably sensitive across at least a substantial portion of the visible spectrum. The above terminology will apply whether or not the particular photosensor is further filtered to keep out infrared or other non-visible light. Although the particular technology for receiving reflected light from an image and deriving therefrom useable signals is not immediately germane to this disclosure, typical technologies for such a purpose are CMOS or CCD.

FIG. 1 shows elements of an exemplary raster input scanner, designated generally by the numeral 100, of the type adapted to use a scanning array, or sensor bar, 10. Sensor bar or array 10, in this embodiment, comprises a linear full width array having a scan width substantially equal to or slightly greater than the width of the largest document or other object to be scanned. Array 10 collects reflected light from a line-like area extending across the width of a generally rectangular transparent platen 104, sized to accommodate the largest original document to be scanned. Array 10 is supported for reciprocating scanning movement in the direction depicted by arrows 105 below platen 104 by a movable scanning carriage 106. One or more lamp and reflector assemblies forming a light source 108 are provided for illuminating the line-like area on which array 10 is focused. Single documents to be scanned are supported on platen 104. Alternately, a stack of sheets can be loaded in the input tray of a sheet feeder 110, of a design generally known in the art, which causes image-bearing sheets to move past sensor bar 10 while it is stationary in a parking position. In either case, image-bearing sheets are caused to move relative to the array 10 along a process direction which is perpendicular to the array direction (i.e., the direction which the array extends). Although FIG. 1 shows a full-page-width array 10, another common embodiment of an input scanner uses a relatively short linear array, which receives reflected light from an image through reductive optics.

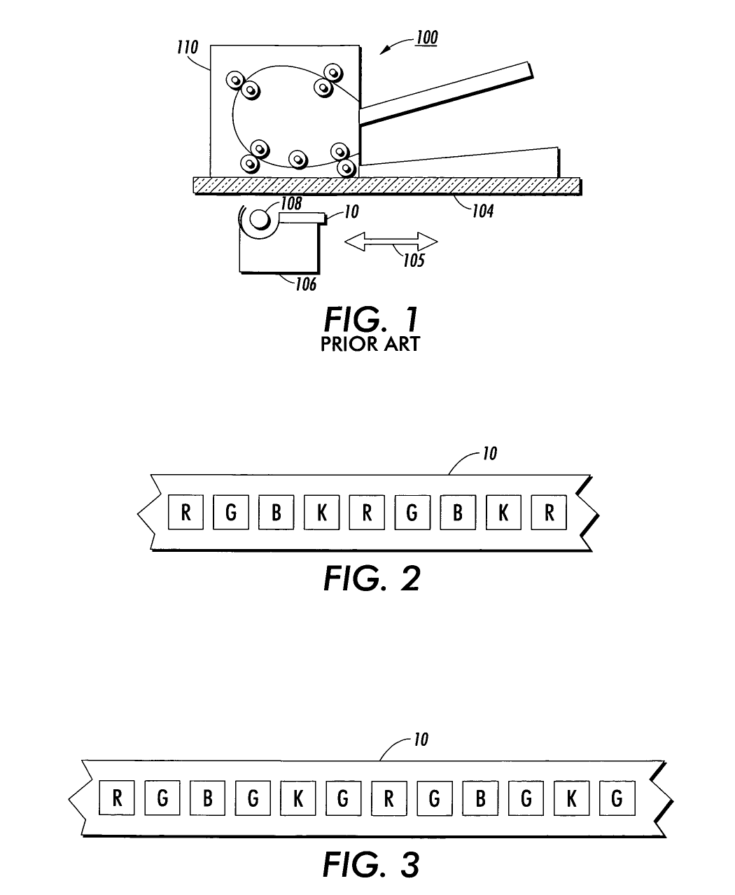

FIGS. 2-5 are plan views of various embodiments of filter configurations for a single linear array of photosensors forming the array 10 in FIG. 1. In the Figures, each photosensor is marked corresponding to its filtering arrangement: R is red-filtered, B is blue-filtered, G is green-filtered, and K is “clear,” as those terms are defined above.

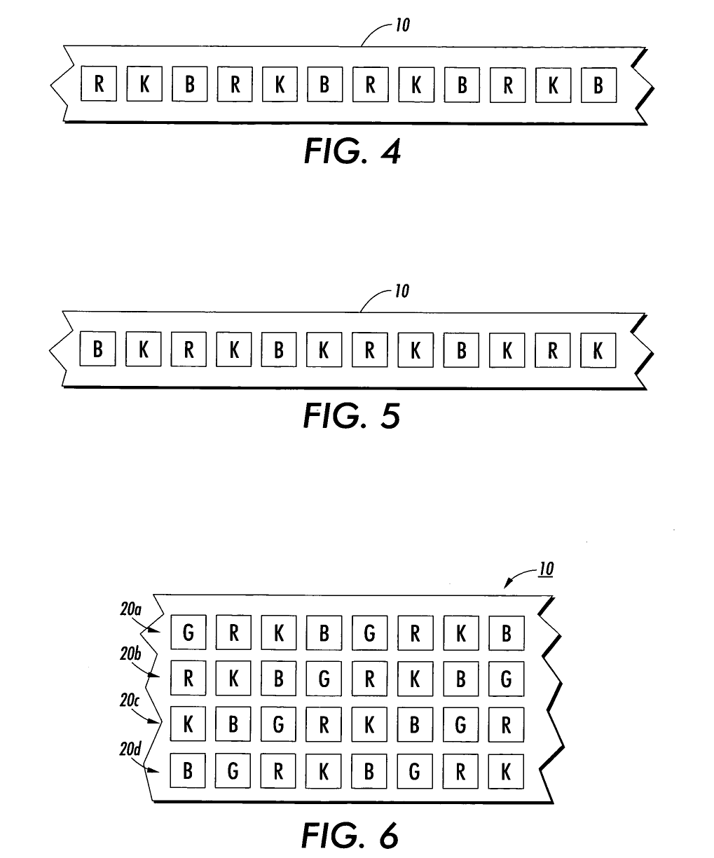

In each of the FIGS. 2-5, there is exhibited along the single linear array a repeating pattern of filtered photosensors, i.e., the repeating pattern assigns filtering for a certain number of photosensors, such as three, four, or six; the pattern is repeated for the entire effective length of the linear array, along the array direction. In FIG. 2, the pattern which is repeated is RGBK; in FIG. 3, RGBGKG; in FIG. 4, RKB; in FIG. 5, BKRK. In all cases, downstream circuitry and software (not shown) takes the filtering into account to derive a full-color image as an original image is scanned through the process direction.

With sufficiently small-sized photosensors, a single linear array of photosensors can be used to record, with sufficient fidelity and resolution, typical color hard-copy images. The use of a clear or K photosensor within the repeating pattern allows the presence of a photosensor with a relatively high sensitivity to be used. If no G is used in a particular pattern, the signal corresponding to green light can be satisfactorily derived from the red, blue, and clear signals. When a clear photosensor is used, it may be desirable to provide a neutral density filter on the K photosensors, to make the overall sensitivity of the K photosensors comparable to the color-filtered photosensors.

Although blue, red, and green are discussed above as “primary colors,” the primary colors of other color systems may be applied as well, such as yellow, magenta, and cyan. Also, although the embodiment shows the K photosensors to be clear, other possible embodiments can include what can be broadly called “non-primary” filtered photosensors as the K photosensor. For instance, in an RGB primary color system, some non-primary color filters in the K position could be orange or blue-green. Also, within the classification of non-primary photosensors are those which are sensitive to “high-pass” or “low-pass” portions of the spectrum, e.g., sensitive in the range of a certain wavelength and longer.

FIG. 6 is a plan view of photosensors in another embodiment, in which multiple linear arrays are incorporated in the same chip, and are generally close to each other. It is well known in the art to provide such a basic multi-row architecture in which each row is entirely filtered to one primary color. In the FIG. 6 embodiment, the array 10 comprises four rows, 20a, 20b, 20c, 20d. Each row 20a, 20b, 20c, 20d exhibits a repeating pattern of filtered photosensors, and the repeating patterns in the respective rows are offset from each other along the array direction, as shown. Such an arrangement can be used for a high-resolution scanning apparatus, and can be adapted from an existing multi-row chip hardware design by placement of the color filters.

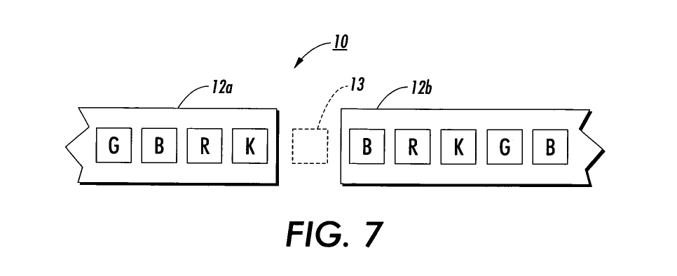

As mentioned above, an array 10 is typically formed in one or more photosensor chips, of a general design familiar in the art. In a multi-chip configuration, a set of chips, each having a linear array of photosensors thereon, is abutted to form a single, page-width array. One practical problem with such a multi-chip array arises if the repeating pattern of filtered photosensors is of a length which is not integral with the total number of photosensors on a single chip. In such a case, if it is desirable that each chip have the same filter pattern, there will be one or more “left over” photosensors which do not complete a repeating pattern. FIG. 7 is a plan view of an abutment area between two abutted chips, 12a and 12b, along the array 10, showing how the extra-photosensor problem is addressed. Here, at one end of each chip such as 12a, the last photosensor in the array does not complete the sequence RGB, requiring that a gap be left between chip 12a and chip 12b. A virtual photosensor 13 can be thought to fill in the space, so that the repeating pattern can be resumed in a consistent way between one end of chip 12a and the adjacent end of chip 12b. In one embodiment, the virtual photosensor 13 between adjacent chips is simply treated so as to contribute a dummy signal when charge signals are read out of the page-width array. The leaving out of photosensor 13 of course will cause a gap in the area of the image being scanned, but this can be overcome by signal interpolation or other techniques. Depending on the divisibility of the number of photosensors on the chip and in the repeating pattern, a plurality of virtual photosensors 13 may be taken into account per chip as needed.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. An imaging apparatus, comprising
a first linear array of photosensors arranged along an array direction;
the photosensors exhibiting a repeating pattern along the array direction, the repeating pattern including a first photosensor filtered to a first primary color, a second photosensor filtered to a second primary color, and a non-primary photosensor.

2. The apparatus of claim 1, the repeating pattern further including a third photosensor filtered to a third primary color.

3. The apparatus of claim 1, the repeating pattern further including a third photosensor filtered to the second primary color.

4. The apparatus of claim 3, wherein the second primary color is green.

5. The apparatus of claim 1, wherein the repeating pattern includes only the first photosensor, the second photosensor, and the non-primary photosensor.

6. The apparatus of claim 1, wherein the first primary color is red and the second primary color is blue.

7. The apparatus of claim 1, further comprising
means for moving a substrate relative to the linear array along a process direction, and
wherein the array direction is substantially perpendicular to the process direction.

8. The apparatus of claim 1, further comprising
a second linear array of photosensors, parallel to the first linear array, the photosensors of the second linear array exhibiting a repeating pattern along the array direction identical to the repeating pattern of the first linear array.

9. The apparatus of claim 8, the pattern in the second linear array being offset relative to the pattern in the first linear array.

10. The apparatus of claim 8, further comprising
a third linear array of photosensors, parallel to the first linear array, the photosensors of the third linear array exhibiting a repeating pattern along the array direction identical to the repeating pattern of the first linear array.

11. The apparatus of claim 10, the pattern in the third linear array being offset relative to the repeating pattern in the second linear array.

12. The apparatus of claim 10, further comprising
a fourth linear array of photosensors, parallel to the first linear array, the photosensors of the third linear array exhibiting a repeating pattern along the array direction identical to the repeating pattern of the first linear array.

13. The apparatus of claim 12, the pattern in the fourth linear array being offset relative to the repeating pattern in the third linear array.

14. The apparatus of claim 1, wherein the non-primary photosensor is clear.

15. The apparatus of claim 1, wherein the non-primary photosensor is filtered orange.

16. The apparatus of claim 1, wherein the non-primary photosensor is filtered blue-green.

17. The apparatus of claim 1, wherein the repeating pattern assigns filtering for six photosensors.

18. The apparatus of claim 17, wherein three of the photosensors in the repeating pattern are filtered green.
